(19) United States
(12) Patent Application Publication
(10) Pub. No.: US 2025/0375744 A1
(43) Pub. Date: Dec. 11, 2025

(54) APPARATUS, DEVICE AND METHOD FOR MIXING GASSES

(71) Applicant: TORMENE INDUSTRIALE SRL UNIPERSONALE, Mestrino (IT)

(72) Inventors: Filippo Maria TORMENE, Villafranca Padovana (PD) (IT); Federico Franco BORDIN, Cusago (MI) (IT)

(21) Appl. No.: 19/107,671

(22) PCT Filed: Aug. 31, 2023
(86) PCT No.: PCT/IT2023/050199

§ 371 Date: Feb. 28, 2025

(30) Foreign Application Priority Data
Sep. 2, 2022 (IT) 102022000018036

(51) Int. Cl. B01F 25/312; B01F 23/10; B01F 35/213; B01F 35/221

(52) U.S. Cl. CPC B01F 25/3123; B01F 23/19; B01F 25/3121; B01F 25/31242; B01F 35/213; B01F 35/2217

(57) ABSTRACT

A device for mixing gasses has a tubular body with an axial passage channel for the introduction of a first gas and at least one radial supply channel for the introduction of a second gas. The device also includes a mixer. A corresponding apparatus and method for mixing gasses are also described.

### FIELD OF THE INVENTION

The present invention concerns an apparatus, a device and method for mixing gasses, in this specific case hydrogen gas and natural gas, which find application in the energy sector, in particular in natural gas distribution infrastructures, large industries, laboratories.

### BACKGROUND OF THE INVENTION

Renewable energies-such as solar, wind and hydroelectric-are unstable, not always suitable for consumption when produced and often fail to be properly stored.

One of the most interesting ones is so-called “green” hydrogen starting from the hydrolysis of water. Green hydrogen can be used in different sectors, such as transport, the production of heat for industrial use, even being introduced in gas transportation and distribution networks.

Introducing green hydrogen in gas transportation and distribution networks represents both an effective method for decarbonization and also a development stimulus for the hydrogen market itself.

For this purpose, apparatuses for mixing a certain amount of hydrogen into a flow of natural gas flowing inside a pipeline are known. Such apparatuses typically comprise a mixing device, also called a mixer, connected to both a natural gas supply line and a hydrogen gas supply line, and also to a mixed gas delivery line.

Known apparatuses also comprise components for controlling and measuring the gas flows which are disposed upstream and downstream of the static mixer.

It is also known in the state of the art to use the Venturi effect in order to mix together two gasses. The Venturi effect creates a low-pressure zone within the constrained section of the gas passage, thus creating a suction effect. This suction effect is utilized for the introduction of a second gas to be mixed with a first one.

A single venturi-type tubular body is for example disclosed in U.S. Pat. No. 6,132,629 A, which uses an axial passage channel to accelerate the first gas and then introduces the second gas radially.

US2019/085794 employs a plurality of venturi nozzles to generally improve the homogeneity of a gas mixture.

One of the disadvantages of known apparatuses is that they are not able to ensure a mixture that has characteristics, chemical as well as physical, which are constant over time, such as for example the mixing percentage of hydrogen gas in the flow of natural gas.

Another disadvantage of known apparatuses is that their control is particularly complicated, whereby the fluctuations in the characteristics of the mixture are not easily mitigated with short response times.

Another disadvantage of known apparatuses is that current mixers are not able to guarantee a homogeneous mixture, which is a fundamental requirement both for the end user, in terms of safety and guaranteed calorific value, and also for the efficient maintenance of gas transportation pipelines whose materials are particularly “stressed” by hydrogen molecules which, since they are very small, can permeate outward with greater ease if present in clusters.

In particular, when mixing hydrogen and natural gas it is essential to guarantee a high homogeneity level. This is due to the difference in hydrogen and natural gas properties, such as density. An inhomogeneous mixture could lead to stratification and pockets of undesiderable hydrogen concentration in the mixture, which could lead to damage to equipment due to the hydrogen embrittlement and result in an inaccurate measure of hydrogen concentration in the mixture.

There is therefore the need to perfect an apparatus, device and method for mixing gasses that can overcome at least one of the disadvantages of the state of the art.

One purpose of the present invention, which corresponds to the technical problem to be resolved, is to provide an apparatus and perfect a method capable of simplifying, making safe and reliable the operations of mixing hydrogen gas, especially, but not only, along the natural gas transportation and distribution lines, that is, gas pipelines.

Another purpose of the present invention is to provide a mixing device, also called a mixer, which is compact, consists of a limited number of components, is easy to maintain and above all modular, that is, able to manage in a simple manner different mixing percentages of hydrogen gas with sufficient uniformity.

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

In accordance with the above purposes and to resolve the technical problem disclosed above in a new and original way, also achieving considerable advantages compared to the state of the prior art, a device for mixing gasses according to the present invention has a tubular containing body provided with an axial passage channel for the introduction of a first gas, which can be natural gas, and at least one radial supply channel for the introduction of a second gas, which can be hydrogen gas, and mixing means disposed along the passage channel.

In accordance with one aspect of the present invention, the mixing means comprise:
a plurality of means, in particular but not only venturi nozzles, to accelerate the first gas and allow the introduction of the second gas;

1- feed chamber in fluidic communication both with the venturi nozzles and also with the at least one supply channel, and in sequence
a first mixing chamber, in fluidic communication with the venturi nozzles;
a second mixing chamber, in fluidic communication with the first mixing chamber and downstream with the passage channel, and a peripherally perforated mixing cylinder disposed inside it.

In the description that follows, and in the claims, we will use the term venturi nozzles to include any possible similar or equivalent tubular structure configured to accelerate the flow of a gas from an entrance to an exit of the tubular structure.

The provision of a plurality of acceleration means allows to guarantee a higher level of homogeneity between the two gasses, with respect to the conventional mixing means.

In fact, such a configuration of the device allows to achieve, in a very simple manner, a particularly homogeneous mixture of gasses.

In accordance with one aspect of the present invention, the venturi nozzles are mounted cantilevered through the feed chamber. Moreover, the venturi nozzles have a throat section defined by an injection element of their own provided with a plurality of injection channels in fluidic communication with the feed chamber.

In accordance with another aspect of the present invention, each injection element is interchangeable, with a number of injection channels correlated to a given mixing percentage of the second gas in the first gas. This characteristic makes the device “modular”, that is, capable of guaranteeing mixing percentages between the two gasses in accordance with the needs of the customer and the specific application.

In accordance with another aspect of the present invention, the feed chamber is in fluidic communication with all the venturi nozzles. This configuration makes the device particularly simple to manage.

According to a variant of the present invention, the feed chamber can be divided into a number of feed compartments, wherein each of such feed compartments is in fluidic communication with a respective venturi nozzle and with a respective supply channel. This characteristic allows to manage the mixing in a particularly flexible manner, within a percentage range of the mixture of the second gas in the first gas which can be, for example, comprised between 1% and about 20%, without intervening by changing the injection elements.

In accordance with another aspect of the present invention, the first mixing chamber is provided with a baffle having a plurality of peripheral apertures which are radially misaligned with respect to the venturi nozzles. This characteristic allows the flow at exit from the venturi nozzles to slow down and deviate radially, generating remixing or recirculation vortices.

In accordance with another aspect of the present invention, the second mixing chamber is defined upstream by such baffle and downstream by an additional baffle provided with a plurality of through holes disposed in a central zone of the passage channel.

In accordance with another aspect of the present invention, the mixing cylinder is peripherally provided with a plurality of additional holes disposed at a radial height lower than a radial height of the apertures and greater than a radial height of the holes, the radial heights being measured with respect to a central longitudinal axis of the device.

Some embodiments of the present invention concern an apparatus for mixing gasses comprising:
the mixing device;
a first feed line for feeding a first gas, a second feed line for feeding a second gas, and a delivery line for delivering the mixed gas, which are fluidically connected to the mixing device;
instrumentation for measuring and/or adjusting one or more of either the thermodynamic, chemical or flow properties of the gasses;
a control unit operatively connected to the instrumentation.

In accordance with another aspect of the present invention, that is correlated to the first aspect above disclosed, the instrumentation comprises at least one flow rate adjustment member disposed on the second feed line and an instrument for measuring the volumetric percentage of the second gas disposed on the mixed gas delivery line. Moreover, the control unit is configured to command the flow rate adjustment member at least on the basis of a measurement performed by the volumetric percentage measuring instrument.

In accordance with another aspect of the present invention, that is also correlated to the first aspect, the instrumentation comprises flow meters of the gasses and an instrument for measuring the chemical composition of the mixture of the gasses. Moreover, the control unit is configured to command the flow rate adjustment member also on the basis of respective measurements performed by the flow meters and the chemical composition measuring instrument.

Some embodiments described here also concern a corresponding method for mixing gasses comprising:
supplying the first gas to the mixing device through the first feed line and measuring one or more of either the thermodynamic, chemical or flow properties of the first gas;
supplying the second gas to the mixing device through the second feed line and measuring one or more of either the thermodynamic, chemical or flow properties of the second gas;
controlling at least one flow rate of the second gas by means of the control unit;
delivering the mixture of the first and second gasses at exit from the mixing device through the mixed gas delivery line.

In accordance with the above-mentioned method, the flow rate is adjusted by means of the flow rate adjustment member at least on the basis of a measurement performed by the instrument for measuring the volumetric percentage of the second gas present in the mixture.

In accordance with the above-mentioned method, the flow rate can also be adjusted on the basis of respective measurements performed by the flow meters of the gasses and by the instrument for measuring the chemical composition of the mixture to measure the percentage of the second gas present.

We must clarify that the thermodynamic properties can typically be pressure, temperature, density, viscosity; the chemical properties can be chemical composition; the flow properties can be a speed, an acceleration, a flow rate.

### DESCRIPTION OF THE DRAWINGS

These and other aspects, characteristics and advantages of the present invention will become apparent from the following description of some embodiments, given as a non-restrictive example with reference to the attached drawings wherein:

FIG. 1 is a block diagram of an apparatus for mixing gasses according to the present invention;

FIG. 2 is a cross section of a device for mixing gasses according to the present invention;

FIG. 3 is a longitudinal section along the section plane III-III of FIG. 2;

FIG. 4 is a cross section of another embodiment of the device for mixing gasses according to the present invention;

FIG. 5 is a longitudinal section along the section plane V-V of FIG. 4.

We must clarify that in the present description the phraseology and terminology used, as well as the figures in the attached drawings also as described, have the sole function of better illustrating and explaining the present invention, their function being to provide a non-limiting example of the invention itself, since the scope of protection is defined by the claims.

To facilitate comprehension, the same reference numbers have been used, where possible, to identify identical common elements in the drawings. It is understood that elements and characteristics of one embodiment can be conveniently combined or incorporated into other embodiments without further clarifications.

### DESCRIPTION OF SOME EMBODIMENTS OF THE PRESENT INVENTION

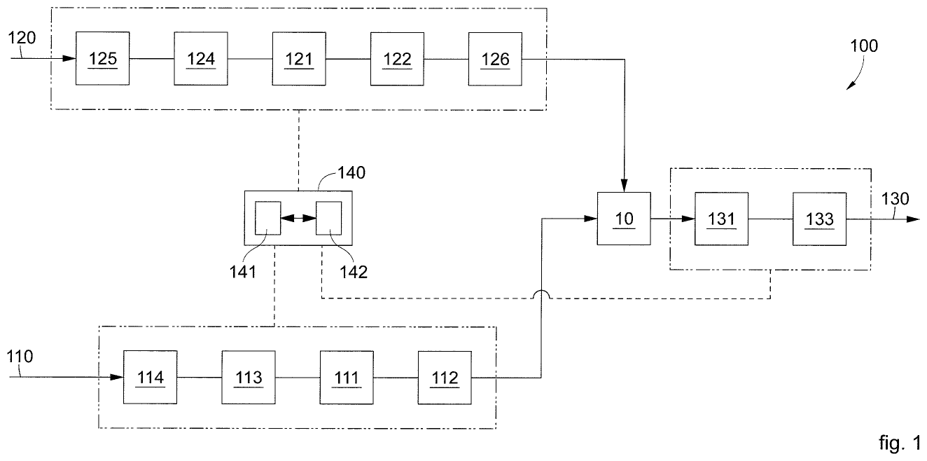

With reference to FIG. 1, an apparatus 100 according to the present invention for mixing gasses above all, but not only, along natural gas transportation and distribution lines, that is, gas pipelines, comprises a mixing device 10, also called a mixer, of the static type, a first feed line, or natural gas feed line 110, a second feed line, or hydrogen gas feed line 120, and a mixed gas delivery line 130, which are fluidically connected to the mixing device 10, the first two at entry and the third at exit.

The apparatus 100 comprises instruments for measuring the thermodynamic properties of the individual gasses to be mixed, in this specific case pressure meters 111, 121 and temperature meters 112, 122 disposed on the respective feed lines 110, 120.

The apparatus 100 comprises instruments 113, 133 for measuring the chemical composition, respectively, of the natural gas and of the mixture at exit from the mixing device 10.

According to a possible implementation, the chemical composition measuring instruments 113, 133 can comprise a gas chromatograph device which, at least for the analysis of the final mixture, can also be used for the purpose of monitoring the percentage of hydrogen gas in the mixture.

The apparatus 100 comprises instruments for measuring the flow rates of the individual gasses to be mixed, in this specific case flow meters 114, 124 disposed on the respective feed lines 110, 120.

The apparatus 100 also comprises an instrument 131 for measuring the volumetric percentage of hydrogen gas in the mixture at exit from the mixing device 10. The volumetric percentage measuring instrument 131 is selected in order to maximize accuracy in typical mixing ranges (from about 0.5% to about 10%, up to as much as 20%) and to be insensitive to variations in pressure and temperature of the mixture. By way of example only, hydrogen analyzers with flow sampling, integrated pressure reduction and thermal conductivity, resistive or capacitive sensors are preferred to densimeters, where there is a greater influence of pressure and operating temperature as well as reduced accuracy in the case of reduced volumetric mixing percentages.

Pressure adjustment members 125 and flow rate adjustment members 126 are present on the hydrogen gas feed line 120.

The apparatus 100 comprises a control unit 140 operatively connected to the pressure meters 111, 121, to the temperature meters 112, 122, to the chemical composition measuring instruments 113, 133, to the flow meters 114, 124, to the volumetric percentage measuring instrument 131, to the pressure 125 and flow rate 126 adjustment members, which together define instrumentation for measuring one or more of either the thermodynamic, chemical or flow properties of the gasses.

The control unit 140 comprises a central processing unit, or CPU, 141 and at least one memory unit 142 connected thereto, in which at least one control algorithm is stored which is capable of causing the CPU 141 itself, in response to at least one measurement signal generated by the instrument 131 for measuring the volumetric percentage of hydrogen gas in the mixture, to generate a control signal for the flow rate adjustment member 126.

Favorably, the control signal for the flow rate adjustment member 126 can also be generated on the basis of further measurement signals generated by the flow meters 114, 124 and by the instrument 133 for measuring the chemical composition of the gas mixture. This allows to minimize the risks linked to failures that may occur to the individual components and to improve the accuracy of the control.

It is clear that the apparatus 100 can comprise other measurement and/or control components which can be easily implemented by a person of skill in the art. We must clarify that the disposition of the components visible in FIG. 1 does not necessarily reflect the actual disposition in the apparatus 100.

Operationally, the apparatus 100 receives the natural gas from the natural gas feed line 110 and performs the measurement of the flow rate (mass or volumetric correct at nominal conditions), the characterization of the chemical composition and the measurement of the pressure by means of the flow meter 114, the pressure meter 111 and the chemical composition measuring instrument 113, respectively.

The natural gas is then introduced into the mixing device 10 where the hydrogen gas is correspondingly injected through the hydrogen gas feed line 120.

Downstream of the mixing device 10, the gas mixture obtained is analyzed in order to measure the volume percentage of hydrogen gas, by means of the volumetric percentage measuring instrument 131, and to make available the exact chemical composition of the mixture and its calorific value, by means of the chemical composition measuring instrument 133.

The continuous measurement of the volume percentage of hydrogen gas in the mixture constitutes the main variable of the hydrogen gas flow rate control cycle operated by the control unit 140.

The hydrogen gas supplied through the hydrogen gas feed line 120 must have a pressure at least equal to the minimum pressure of the natural gas into which it will be injected, as well as a mass flow rate greater than a minimum limit manageable by the apparatus 100. In the absence of such conditions, the apparatus 100 stops mixing.

The hydrogen gas is first brought to a constant pressure by means of the pressure adjustment members 125. The pressure adjustment value must be higher than the maximum pressure provided in the natural gas feed line 110.

The hydrogen flow rate and the hydrogen pressure are then measured through the pressure meter 121 and the flow meter 124, respectively.

At this point, the hydrogen gas is controlled by means of the flow rate adjustment member 126, which is commanded by the control unit 140 in order to pursue a set-point of volumetric percentage of hydrogen in the natural gas-hydrogen mixture. The flow rate adjustment member 126 acts as a “brake” against a flow of hydrogen gas that would naturally flow from the upstream high pressure point to the low pressure injection point given by the acceleration of the natural gas inside the mixing device 10.

The control logic implemented by the control unit 140 also exploits the direct natural gas and hydrogen flow rate measurements in order to improve accuracy and dynamic response. The same direct flow rate measurements are also used for a reserve control cycle that is activated in the event of failure of the hydrogen gas volumetric percentage measuring instrument 131 and/or discrepancy between continuous measurement and monitoring measurement and simultaneous equality of indirect measurement of hydrogen percentage through flow rates, pressures and temperatures of the individual gasses and monitoring measurement. This control logic is intended as emergency logic for the ultimate purpose of restoring the normal operation of the apparatus 100.

The hydrogen gas is mixed with the natural gas inside the mixing device 10 according to the principles described below.

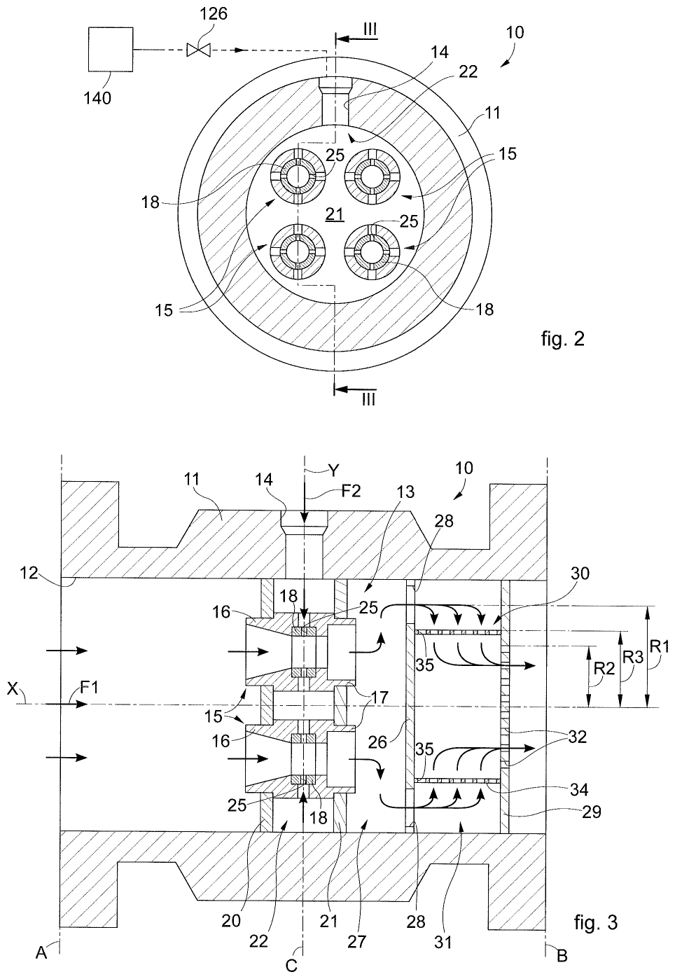

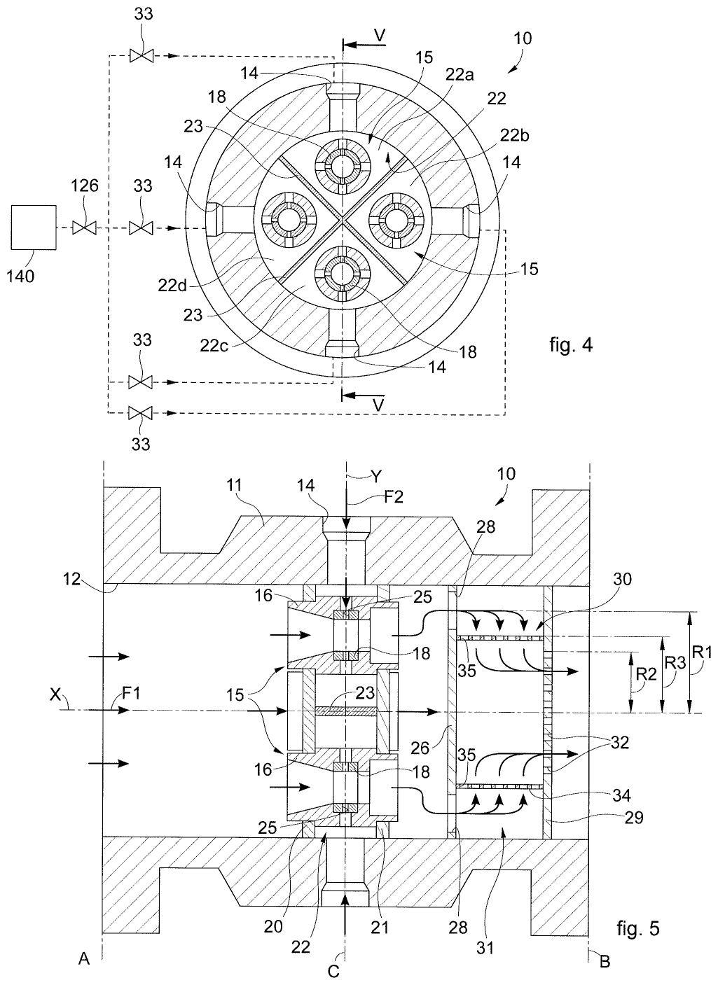

With reference to FIGS. 2 and 3, the mixing device 10 comprises a tubular containing body 11 provided with a main passage channel 12, where the natural gas is introduced, and at least one secondary supply channel 14 from where the hydrogen gas is supplied.

A single supply channel 14 is provided in the embodiment of FIG. 2, while a plurality of supply channels 14 are provided in that of FIG. 3, in this specific case four.

The passage channel 12 has a prevalent development along a longitudinal axis X, between an inlet section A and an outlet section B, while the at least one supply channel 14 has a development along a radial axis Y, substantially orthogonal to the longitudinal axis X, and is located in an intermediate section C between said sections A and B.

The inlet A and outlet B sections can be configured for connection with a pipe, a duct, a channel or other connection, and they can be provided with flanges or fittings in a manner known per se.

In this specific case, the inlet A and outlet B sections are respectively connectable, during use, to the natural gas feed line 110 and to the mixed gas delivery line 130.

The at least one supply channel 14 is connectable, during use, to the hydrogen gas feed line 120.

By way of example only, the inlet section A and the outlet section B can have a nominal diameter comprised between about 50 mm and about 600 mm.

Operationally, the natural gas is introduced into the passage channel 12 through the inlet section A in a flow direction F1 that is generally parallel to the longitudinal axis X, the hydrogen gas is introduced into the passage channel 12 through the at least one supply channel 14 in a radial flow direction F2, that is, orthogonal to the longitudinal axis X, and the mixed gas exits from the passage channel 12 through the outlet section B in a flow direction F3 that is generally parallel to the longitudinal axis X, that is, to the flow direction F1.

The passage channel 12 can be divided into three zones: a first zone in which, when the mixing device 10 is in operation, only natural gas is present, a second zone where the hydrogen gas is introduced into the flow of natural gas through the at least one supply channel 14, and a third zone where the two gasses actually mix and are homogenized.

The mixing device 10 comprises mixing means 13 disposed inside the containing body 11 along the passage channel 12 and fluidically connected to the at least one supply channel 14.

The mixing means 13 comprise a plurality of venturi nozzles 15 configured to accelerate the natural gas and allow the introduction of the hydrogen gas.

The venturi nozzles 15 are disposed with their own axes parallel to the longitudinal axis X and therefore to the flow direction F1. In the example of FIGS. 2 and 3, the number N of venturi nozzles 15 is four. In general, the number N of venturi nozzles 15 can be comprised between 1 and 32, preferably between 4 and 8.

The venturi nozzles 15 are preferably disposed in parallel, that is, with their own axes parallel to each other. The use of multiple venturi nozzles 15 in parallel allows to accelerate the flow of natural gas, while maintaining better control of the acoustic level of the mixing device 10.

The venturi nozzles 15 are disposed in a position, along the longitudinal axis X, straddling the intermediate section C. The venturi nozzles 15 are preferably disposed symmetrically with respect to the longitudinal axis X.

The venturi nozzles 15 can have the same size as each other or have different sizes. The size can be characterized by a longitudinal and/or transverse dimension.

Each venturi nozzle 15 comprises a converging segment, a throat section and a diverging segment, which are respectively defined by a converging element 16, from which the flow of natural gas enters, an intermediate element 18, from which the injection of hydrogen gas occurs, and a diverging element 17, from which the flow of hydrogenated natural gas exits.

As will be described in more detail below, the intermediate element 18 is configured to allow the injection of the hydrogen gas inside the venturi nozzle 15. Therefore, the intermediate element 18 will also alternatively be called an injection element.

Operationally, the natural gas entering the venturi nozzle 15 undergoes an acceleration along the converging segment until it reaches its maximum velocity in the throat section, in correspondence with the injection element 18. Favorably, the passage areas are calculated in order to avoid sonic flow in the throat, with suitable safety factors.

The purpose of the acceleration is twofold: a) to reduce the pressure in the throat section so as to favor the injection of the hydrogen gas by limiting the overpressure required for the correct operation of the mixing device 10; b) to generate the gas mixture in a situation of high flow velocity so as to exploit the subsequent reduction in velocity to make the mixture itself more homogeneous.

According to the embodiment of FIGS. 2 and 3, the venturi nozzles 15 are formed by distinct and separate elements 16, 18, 17, joined by means of mechanical members in a releasable manner. This configuration allows at least an interchangeability of the injection element 18, the purpose of which will be explained below.

According to a variant not shown, the venturi nozzles 15 can be made in a single body.

The mixing means 13 comprise a feed chamber 22 for feeding the venturi nozzles 15.

The feed chamber 22 is in fluidic communication with the at least one supply channel 14 and with the venturi nozzles 15 by means of the injection elements 18.

The feed chamber 22 is defined axially by two foils, or walls, 20, 21 distanced along the longitudinal axis X and, peripherally, by the containing body 11.

Overall, the feed chamber 22 is isolated with respect to the first and second zone of the passage channel 12, that is, the zone upstream with respect to the wall 20 and the zone downstream with respect to the wall 21. In particular, a first foil 20 is closer to the inlet section A while a second foil 21 is closer to the outlet section B.

The foils 20, 21 have a substantially circular shape and are disposed orthogonally to the longitudinal axis X.

The venturi nozzles 15 are mounted cantilevered through the feed chamber 22, in particular through the two foils 20, 21, in such a way that the converging element 16 is in fluidic communication with the first zone of the passage channel 12, the injection element 18 is in fluidic communication with the second zone of the passage channel 12, which corresponds to the feed chamber 22, and the diverging element 17 is in fluidic communication with the third zone of the passage channel 12.

The longitudinal distance between the foils 20, 21 is correlated to the longitudinal dimension of the venturi nozzles 15 and to the volume of the feed chamber 22 to be defined.

Between the foils 20, 21 and the containing body 11, and between the apertures present on the foils 20, 21 for the venturi nozzles 15, there are gaskets, in this specific case elastomeric, in order to guarantee the complete separation of the feed chamber 22 from the upstream and downstream zones of the passage channel 12.

In the embodiment of FIG. 2, the feed chamber 22 is in fluidic communication with all the venturi nozzles 15.

In the embodiment of FIG. 3, the feed chamber 22 is divided into a number of feed compartments 22a-22d corresponding to the number N of venturi nozzles 15. The chamber comprises dividing walls 23 to define the feed compartments 22a-22d.

Each feed compartment 22a-22d is in fluidic communication with a respective venturi nozzle 15 and with a respective supply channel 14.

Each supply channel 14 is commanded by means of a separate solenoid valve 33 in order to be able to progressively feed from 1 to N feed compartments 22a-22d, as the desired mixing percentage increases.

The supply channels 14 are fed by means of respective radial tubes, which in turn are connected to the solenoid valves 33 and to a toroidal tube fed by the hydrogen gas feed line 120.

The injection element 18 is positioned inside the feed chamber 22 and is provided with a plurality of injection channels 25 that put the feed chamber 22 in fluidic communication, as a whole or with respect to its individual feed compartments 22a-22d, where the pressurized hydrogen gas is present, with the channel of the venturi nozzles 15.

The feed chamber 22 allows to homogeneously feed the injection channels 25 of the injection element 18 at a pressure that is controlled on the basis of the flow rate values of natural gas injected into the venturi nozzles 15 and of hydrogen gas introduced through the at least one supply channel 14.

This pressure is controlled upstream by the flow rate adjustment members 126.

The section, or passage area, of the injection channels 25 is sized so as to guarantee a velocity of the flow of hydrogen that passes through them always higher than that of the natural gas in the throat section of the channel of the venturi nozzles 15. In other words, the injection of hydrogen gas into the accelerated flow of natural gas occurs at over-speed. This is hindered by the acceleration of the flow of natural gas, but is greatly facilitated by the fact that hydrogen is a light gas which has a sound velocity triple that of natural gas and which can therefore be further accelerated before reaching the flow rate sonic block phenomenon. The difference between the pressure present in the feed chamber 22, or in one of its feed compartments 22a-22d, and the pressure present in the throat section of the venturi nozzles 15 favors the injection of the hydrogen gas.

The injection channels 25 have a favorably tangential direction with respect to the throat channel of the venturi nozzles 15. In this way, the hydrogen gas flow is introduced into the channel of the venturi nozzles 15 tangentially to the natural gas flow, so as to generate a rotational motion (swirl) caused by the combination of the tangential velocity of the hydrogen gas injection with the axial velocity of the natural gas flow. This configuration allows to obtain a first mixing between the two gasses.

According to a variant, the injection channels 25 can have a radial direction with respect to the axis of the channel of the venturi nozzles 15.

The injection element 18 is sized both to manage a maximum volumetric flow rate of hydrogen gas beyond which there are sonic block phenomena in the injection channels 25, and also to guarantee that the injection occurs at over-speed beyond a minimum volumetric percentage of hydrogen in the final mixture. Below this percentage, the injection element 18 can be used without risk, but the entire mixing device 10 works ineffectively.

The injection element 18 can be interchangeable. The replacement of the injection element 18, in order to use the one with the most appropriate number of injection channels 25, allows to manage different mixing percentages of hydrogen gas with sufficient uniformity and avoiding loss of control due to blocked flow phenomena.

The number of injection channels 25 of each injection element 18 can be comprised between about 4 and about 64.

The injection elements 18 mounted simultaneously on the respective venturi nozzles 15 can have the same, or a different, number of injection channels 25.

The mixing percentage of the hydrogen gas can therefore be managed by mounting injection elements 18, each provided with a certain number of injection channels 25.

The mixing percentage can also be managed by providing a configuration of venturi nozzles 15 having different sizes with respective injection elements 18 having a different number of injection channels 25.

The diverging element 17 has a section that diverges sharply with respect to the throat section of the injection element 18. Therefore, the expansion of the mixture is not guided by the diverging element 17 and this allows to promote the radial growth of the rotational motion, improving the mixing of the two gasses.

The mixing means 13 also comprise a first mixing chamber 27 in communication with the venturi nozzles 15 and with the mixing means 13 disposed downstream and described below.

The first mixing chamber 27 is defined by a baffle 26, disposed downstream of the second foil 21, by the second foil 21 itself and, peripherally, by the containing body 11.

The baffle 26 has a cross section substantially equal to the cross section of the passage channel 12 at that given longitudinal height. The baffle 26 has a substantially circular shape and is disposed orthogonally with respect to the longitudinal axis X.

The baffle 26 has a plurality of peripheral apertures 28 that allow the passage downstream of the gasses, at this point partly mixed, at exit from the first mixing chamber 27. Favorably, the apertures 28 are equally distributed peripherally, that is, they have a constant pitch.

The apertures 28 are misaligned both with respect to the longitudinal axis X and also with respect to the axes of the channels of the venturi nozzles 15. For example, the apertures 28 are made at a radial height R1 measured from the longitudinal axis X that is greater than the radial heights measured from the axes of the channels of the venturi nozzles 15.

Therefore, the flow at exit from the venturi nozzles 15 is stopped and deflected radially, being forced to pass through the apertures 28. This configuration generates remixing vortices in the first mixing chamber 27, favoring the mixing of the individual jets at exit from the venturi nozzles 15.

The first mixing chamber 27 assumes an even greater importance in the mixing device 10 of FIG. 3 in which, for example, the feed of a single venturi nozzle 15 would render the system non-symmetrical. The mixing efficiency of the first mixing chamber 27 depends mostly on the natural gas flow rate. Moreover, the system is more asymmetrical the lower the mixing percentage, which, however, belongs to an operating zone where the uniformity of the mixture is less critical with regard to the risks that it entails.

The mixing means 13 also comprise both an additional, or second, toroidal mixing chamber 31 defined by the baffle 26, by an additional baffle 29 disposed downstream of the baffle 26 and, peripherally from the containing body 11, also a hollow mixing cylinder 30 disposed inside the second mixing chamber 31 and in fluidic communication with the latter. The mixing cylinder 30 is disposed with its development axis parallel to, favorably, coincident/coaxial with the longitudinal axis X.

The second mixing chamber 31 is in fluidic communication with the first mixing chamber 27 by means of the apertures 28.

The additional baffle 29 has a cross section substantially equal to the cross section of the passage channel 12 at that given longitudinal height. The additional baffle 29 is disposed orthogonally to the longitudinal axis X.

The additional baffle 29 is provided with a plurality of through holes 32 disposed in a central zone around the longitudinal axis X. The holes 32 have a development parallel to the longitudinal axis X. The holes 32 are disposed within a circular area having a radial height R2.

The mixing cylinder 30 has a peripheral wall 34 provided with a plurality of additional radial holes 35 which put the second mixing chamber 31 in fluidic communication with the inside of the mixing cylinder 30.

The peripheral wall 34 is located at a radial height R3 lower than the radial height R1 of the apertures 28 and greater than the radial height R2 of the holes 32.

Therefore, the gas entering the second mixing chamber 31 through the apertures 28 is forced to pass radially through the additional holes 35 of the mixing cylinder 30 and subsequently through the holes 32 of the additional baffle 29 toward the outlet section B. Inside the second mixing chamber 31 the flow is normalized and subsequently straightened through the holes 32.

It is clear that modifications and/or additions of parts may be made to the apparatus 100, to the device 10 and to the method as described heretofore, without departing from the field and scope of the present invention, as defined by the claims.

It is also clear that, although the present invention has been described with reference to some specific examples, a person of skill in the art will be able to achieve other equivalent forms of apparatus, device and method for mixing gasses, having the characteristics as set forth in the claims and hence all coming within the field of protection defined thereby.

In the following claims, the sole purpose of the references in brackets is to facilitate their reading and they must not be considered as restrictive factors with regard to the field of protection defined by the same claims.

1. A device for mixing gasses, the device comprising:
a tubular body having an axial passage channel configured to receive a first gas and at least one radial supply channel configured to receive a second gas; and
a mixer disposed along the axial passage channel, wherein the mixer comprises:
a plurality of venturi nozzles, configured to accelerate the first gas and to allow introduction of the second gas;
a feed chamber in fluidic communication with the plurality of venturi nozzles and with the at least one radial supply channel;
a first mixing chamber in fluidic communication with the plurality of venturi nozzles;
a second mixing chamber, in fluidic communication with the first mixing chamber and with the axial passage channel; and
a peripherally perforated mixing cylinder disposed inside the second mixing chamber.

2. The device of claim 1, wherein the plurality of venturi nozzles are mounted cantilevered through the feed chamber, and each of the plurality of venturi nozzles comprises an injection element having a plurality of injection channels in fluidic communication with the feed chamber.

3. The device of claim 2, wherein each injection element is interchangeable, and the number of injection channels corresponds to a mixing percentage of the gasses.

4. The device of claim 1, wherein the feed chamber is in fluidic communication with all of the plurality of venturi nozzles.

5. The device of claim 1, wherein the feed chamber is divided into a number of feed compartments, and each of the feed compartments is in fluidic communication with a respective venturi and with a respective supply channel.

6. The device of claim 1, wherein the first mixing chamber comprises a baffle having a plurality of peripheral apertures which are radially misaligned with respect to the plurality of venturi nozzles.

7. The device of claim 6, wherein the second mixing chamber is defined upstream by the baffle and downstream by an additional baffle having a plurality of through holes disposed in a central zone of the passage channel.

8. The device of claim 7, wherein the mixing cylinder has a plurality of additional holes disposed at a radial height lower than a radial height of the plurality of peripheral apertures and greater than a radial height of the through holes, the radial heights being measured with respect to a central longitudinal axis.

9. An apparatus for mixing gasses, the apparatus comprising:
the device of claim 1;
a first feed line configured to feed the first gas to the device;
a second feed line configured to feed the second gas to the device;
a delivery line configured to deliver the mixed gas from the device;
instrumentation configured to measure and/or adjust at least one of a thermodynamic property, a chemical property, or a flow property of the gasses; and
a control unit operatively connected to the instrumentation,
wherein the instrumentation comprise at least one flow rate adjuster disposed on the second feed line and an instrument configured to measure the volumetric percentage of the second gas that is disposed on the delivery line, and
wherein the control unit is configured to command the flow rate adjuster based on a measurement performed by the volumetric percentage measuring instrument.

10. The apparatus of claim 9, wherein the instrumentation comprise;
flow meters associated with the first and second gasses; and
an instrument configured to measure the chemical composition of the mixture of said gasses,
wherein the control unit is further configured to command the flow rate adjuster based on respective measurements of the flow meters and of the chemical composition measuring instrument.

11. The device of claim 1, wherein the second mixing chamber is downstream of the first mixing chamber.
